(19) United States
(12) Patent Application Publication
(10) Pub. No.: US 2026/0054557 A1
(43) Pub. Date: Feb. 26, 2026

(54) SYSTEM FOR ADVERSE WEATHER PROTECTION AND METHODS OF USE THEREOF

(71) Applicant: Torc Robotics, Inc., Blacksburg, VA (US)

(72) Inventors: Pablo Smith, Spicewood, TX (US); William Gray Davis, Austin, TX (US); Akshay Pai Raikar, Austin, TX (US); Joseph R. Fox-Rabinovitz, Austin, TX (US)

(21) Appl. No.: 18/814,341

(22) Filed: Aug. 23, 2024

(51) Int. Cl. B60J 11/04

(52) U.S. Cl. CPC B60J 11/04

(57) ABSTRACT

A system for adverse weather protection is provided. The system including a feature and a structure adjacent to the feature, the structure having a first layer and a second layer. The structure is inflatable around the feature defining a first volume between the feature and the first layer, a second volume between the first layer and the second layer and a third volume external to second layer. The first layer and the second layer are sized and dimensioned such that when the second volume is inflated the structure expands around the feature.

### TECHNICAL FIELD

The field of the disclosure relates to systems for protection against weather and methods of uses thereof and, in particular, to autonomously deployable weather protection systems which can be mounted on autonomous vehicles or other structures.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Autonomous vehicles are deployed and expected to travel through different environments experiencing different weather conditions, including rain, snow, sleet, hail, windstorms, and sandstorms for example. In some cases the weather conditions are so severe that the autonomous vehicle or sensors thereon are at risk of being damaged. For example, hail can dent, scratch, crack, or break the sensors on the autonomous vehicle, potentially rendering the vehicle and/or sensors partially or completely inoperable. Since weather can be unpredictable and rapidly change, the autonomous vehicle will need to include a means for quickly providing protection to the sensors and vehicle when a harmful weather or other ambient event occurs and the vehicle is not garaged or otherwise protected from the potentially harmful ambient conditions.

Currently, fixed structures or covers are used to provide vehicle protection when damaging ambient events such as hail storms occur. The fixed structures may include a suspended net or awning that overlays the vehicle. If a weather event is immanent, and net or awning is to be used to protect the vehicle, the location of the structure supporting the net or awning must be learned and then the vehicle must be driven to the structure location and below the associated net or awning for protection. Because weather conditions can degrade rapidly, it may not be possible to locate a protective structure and then drive the truck to safety beneath the net or awning before the damaging weather event occurs. Similarly, padded or inflated covers require advanced setup, including fully or partially wrapping the vehicle in the cover. Due to the time required to deploy the cover, it may not be possible to deploy the cover in time to effectively protect the vehicle before the damaging ambient conditions occur.

Accordingly, there exists a need for a system and a method for protection against adverse weather conditions that can be deployed and utilized wherever the autonomous vehicle is located.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a system for adverse weather protection is provided. The system including a feature and a structure adjacent to the feature, the structure having a first layer and a second layer. The structure is infaltable around the feature defining a first volume between the feature and the first layer, a second volume between the first layer and the second layer and a third volume external to second layer. The first layer and the second layer are sized and dimensioned such that when the second volume is inflated the structure expands around the feature.

In another aspect, a system for adverse weather protection is provided. The system including a feature and a structure adjacent to the feature, the structure having a plurality of ribs and a cover attached to the plurality of ribs, the structure being movable between a retracted position and a deployed position. When the structure is in the deployed position, the plurality of ribs are arranged around the feature and the cover surrounds the feature.

In yet another aspect, a method for automatic protection against adverse weather is provided. The method including the steps of detecting an adverse weather condition and transmitting a first signal indicative of the adverse weather condition to an adverse weather protection system. The adverse weather protection system including a feature and an structure adjacent to the feature, the structure having a first layer and a second layer, the structure is expandable around the feature defining a first volume between the feature and the first layer, a second volume between the first layer and the second layer and a third volume external to the second layer, and the first layer and the second layer are sized and dimensioned such that when the second volume is inflated the structure expands around the feature. The adverse weather protection system also includes at least one processor configured to receive signals and to execute instructions stored in at least one memory to control a pump operatively connected to the first volume and the second volume. The method also includes the steps of inflating the second volume to expand the structure around the feature in response to the first signal, detecting if the extreme weather condition has stopped, transmitting a second signal indicative that the extreme weather condition has stopped to the extreme weather protection system, and deflating the second volume in response to the second signal.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIG. 4 is a schematic view of a retracted hail protection system;

FIG. 5 is a schematic view of a deployed hail protection system;

FIG. 6 is a schematic view of a retracted hail protection system with a cover;

FIG. 7 is a schematic view of a deployed hail protection system with a cover;

FIG. 8 is a schematic view of a deployed hail protection system with telescoping arms;

FIG. 9 is a schematic view of a partially deployed hail protection system;

FIG. 10 is a cross section view of a hail protection system;

FIG. 11 is a schematic view of a hail protection system on a vehicle;

FIG. 12 is a schematic view of a hail protection system on vehicle sensors;

FIG. 13 is a schematic view of a hail protection system on a trailer;

FIG. 14 is a flow chart of a method of use of a hail protection system;

FIG. 15 is a schematic view of a retracted weather protection system;

FIG. 16 is a front view of FIG. 15;

FIG. 17 is a schematic view of a deployed weather protection system;

FIG. 18 is a front view of FIG. 17;

FIG. 19 is a schematic view of a weather protection system with a reinforced plate;

FIG. 20 is a schematic view of an inflatable weather protection system;

FIGS. 21A-C show a deployment sequence of an inflatable weather protection system; and

FIG. 22 is a flow chart of a method of use of a weather protection system.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As described herein, systems and methods for protection against hail are provided. The hail protection system can be mounted on a vehicle, sensor, or other structure and be movable between a retracted position, when not in use for transport, and a deployed position, for protection against hail. The hail protection system has a plurality of movable arms suspending a sheet between the arms to provide protection thereunder. In some embodiments, the arms are hinged, jointed, or telescoping to provide protection over a wider area while maintaining a smaller footprint while not in use. In some embodiments, the sheet is a tarp, a net, or other flexible fabric.

In some embodiments, the hail protection system is contained in a sectioned cover which protects the components while not in use and may be aerodynamic as not to disrupt the normal functions of the vehicle. The sections of the cover may be attached to a respective arm of the hail protection system such that the cover is opened and deployed simultaneously as the arms move into the deployed position.

In some embodiments, the hail protection system utilized sensors on an autonomous vehicle to detect if there is hail fall. Using this information the hail protection system may autonomously determine if the system needs to be deployed and, if so, deploying the system. Once the sensors detect that hail fall has stopped, the system is retracted and autonomous resumes normal functionality.

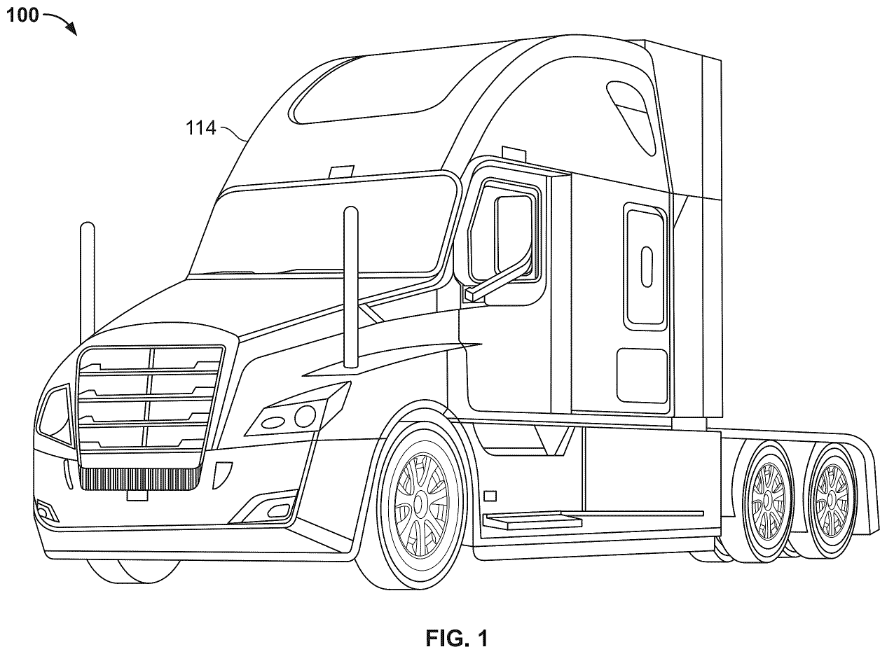

Various embodiments in the present disclosure are described with reference to FIGS. 1-22 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

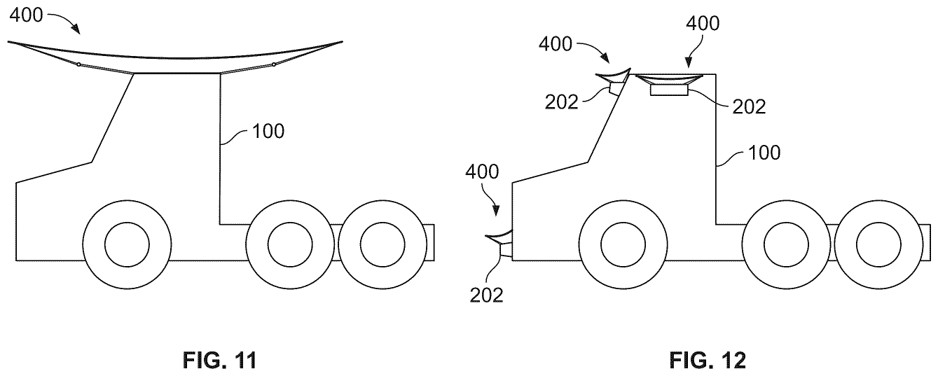

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors. The vehicle may include the hail protection system of the present disclosure that will be described in detail herein. The hail protection system is represented schematically on the vehicle 100 and a trailer in FIGS. 11-13.

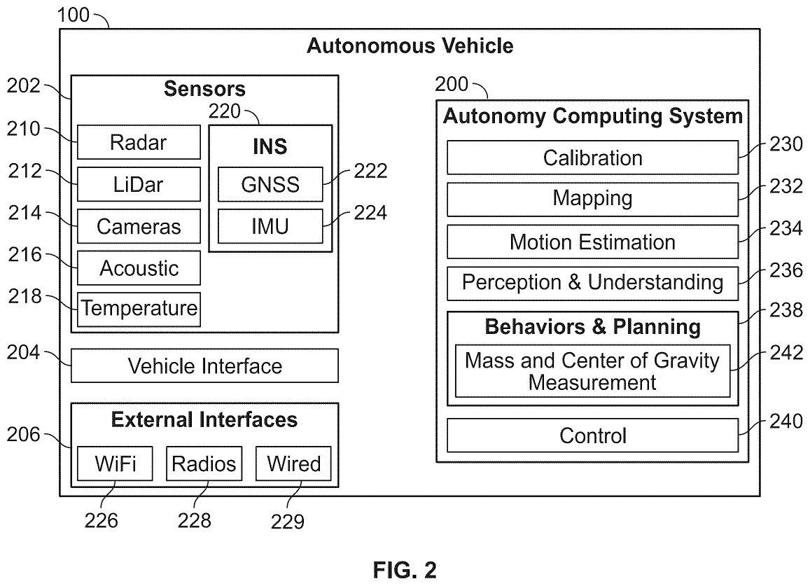

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

In some embodiments, the image data generated by cameras 214 may be transmitted to mission control for one or more of identifying one or more construction markers (or nodes), generating one or more connectivity graphs based upon identified construction markers (or nodes), updating a reference path based upon the one or more connectivity graphs, transmitting the updated reference path to the autonomy vehicle 100 for guiding autonomous vehicle 100 to drive on the updated reference path.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226, radios 228, wired 229, or other wired or wireless connections. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, cither autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an object detection and reference path generator module 242. The object detection and reference path generator module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 242 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

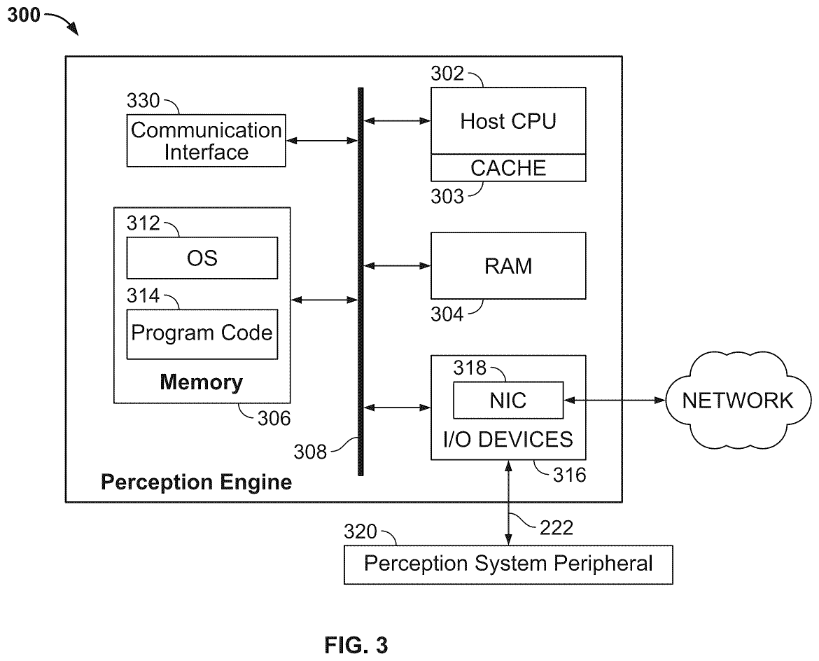

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

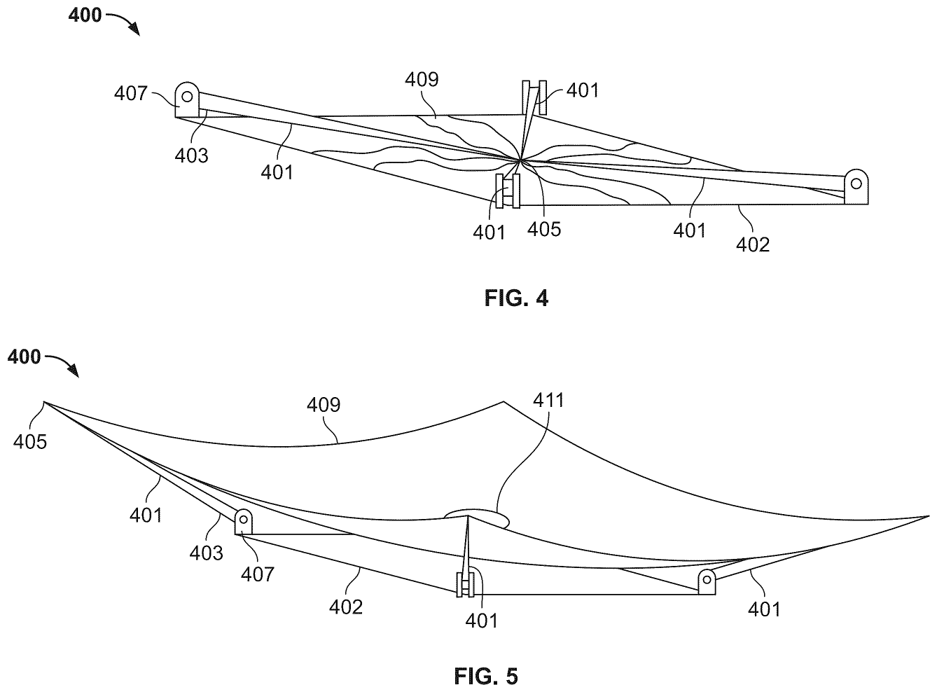

Referring now to FIG. 4, shown is a hail protection system 400 in a retracted position according to some embodiments of the present disclosure. The hail protection system 400 has a plurality of movable arms 401 arranged along the perimeter of a base structure 402. The base structure may be a discrete base that is in turn anchored to the vehicle or other structure being protected by system 400. Alternatively, the arms 401 may be anchored directly to the associated vehicle or structure protected by the hail protection system. The system 400 includes at least one arm 401. As shown in FIG. 4, the system includes four arms 401. Each arm 401 has a first end 403 fixed to the base structure 402 by a respective hinge 407. Each arm also includes a second end 405. The second end 405 may be located in the required location relative to the movable first end. As shown in FIGS. 4 and 5, of the embodiment of the present disclosure, the arms 401 are substantially straight and the second end 405 is opposite the first end 403. The arms 401 are movable, via the respective hinges 407. The arms are movable, between a retracted position shown in FIG. 4, and a deployed position shown in FIG. 5. In the retracted position, each of the second ends of the arms are located proximate the other arm second ends. As shown in the embodiment of the disclosure, the second ends are located at the center of the base 402. The second ends may be located at any suitable location relative to the base. When in the deployed position, the second ends of the arms are rotated and located away from the base 402. See FIG. 5.

In some embodiments, the base structure 402 may comprise the vehicle 100, the cabin 114, one or more of the sensors thereon, a trailer, or an independent structure such as a pole or roof of a building, although not limited thereto. In some embodiments, the hail protection system 400 is retrofit on to a base structure 402, including the base structures proposed herein.

The hail protection system 400 also includes a sheet 409 attached to the second end 405 of each arm 401. The sheet 409 is movable between an extended orientation, shown in FIG. 5 when the arms are deployed, and a collapsed orientation when the arms are retracted as shown in FIG. 4. The sheet 409 can be made of any flexible material, that is able to withstand contact from hail such as for example, canvas, burlap, fabric, woven mesh, or plastic, although not limited thereto. In some embodiments, the sheet 409 has a sewn pocket which adapted to receive the second end 405. The second end 405 is inserted into the pocket. In some other embodiments, the second end 405 is sewn directly into the sheet 409. In some further embodiments, the sheet 409 is connected to the second end 405 by a rope, clasp, latch or other coupling means suitable for connecting cloth to a rigid structure.

The sheet 409 can be moved between a collapsed orientation and an extended orientation when the arms 401 are in the corresponding retracted position and the deployed position. As shown in FIG. 4, in the collapsed orientation, the sheet 409 is folded over itself, in this way the arms 401 and the sheet 409 form a compact assembly occupying a smaller footprint relative to the extended orientation. Additionally, the collapsed arms and sheet are substantially coplanar, enabling effective storage of the retracted assembly when located on a moving vehicle. The coplanar stored assembly is less likely to be affected by the wind passing across the vehicle.

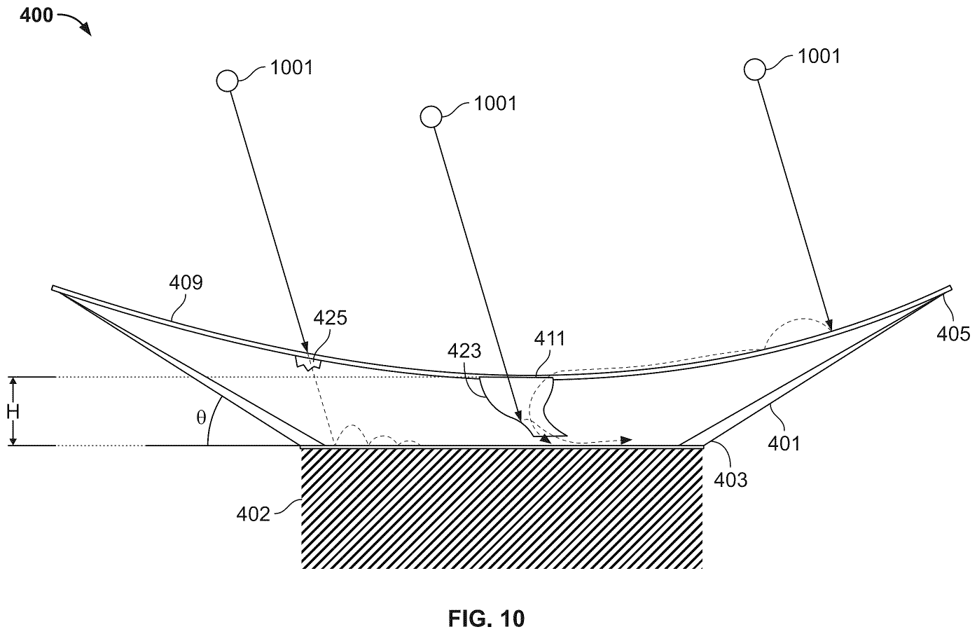

Referring now to FIG. 5, shown is the hail protection system 400 in the deployed position according to some embodiments of the present disclosure. When the arms 401 are in the deployed position, the sheet 409 assumes an extended orientation and is stretched beyond the perimeter of the base 402, to ensure that the system 400 provides suitable protection to the base, sensors or other objects located under the extended sheet. In some embodiments, the sheet 409 may include an orifice 411 serving as a means of egress of any hail or other debris that lands on top of the sheet. The orifice 411 may be positioned on the sheet 409 such that, when the sheet 409 is in the extended orientation, the orifice 411 is at the lowest point on the sheet 409 (also shown in FIG. 10). In an alternate embodiment, the sheet may include any suitable number of orifices.

In some embodiments, as hail falls and lands and settles on the sheet 409, the pitch of the sheet from the upper extent where the sheet is attached to the second ends 405, to the lower extent where the orifice 411 is positioned, contributes to the hail rolling, sliding or otherwise moving toward the lowest point on the sheet 409 by gravity and into the orifice 411. Having dissipated most of the kinetic energy of the hail in the initial impact with the sheet 409, the hail will enter and pass through the orifice 411 and off of the sheet 409, thereby reducing the weight supported by the sheet 409 and suspended between the arms 401.

In some embodiments, the hail protection system 400 is in data communication with the autonomous vehicle 100 or the autotomy computing system 200, such that the autonomous vehicle 100 or the autotomy computing system 200 can actuate the arms 401 between the retracted position and the deployed position. Motors or other means for rotating the arms between retracted and deployed positions are connected to the arms at the first ends. A signal is provided to the motors or other suitable device producing the desired arm movement. The desired arm movement may comprise extending rotating or otherwise moving the arms. Sensors 202, for example the temperature sensor 218 or cameras 214, may detect hail falling proximate the hail protection system. The sensors provide data to the autonomy computing system 200 indicating that the ambient presence of hail has been detected. Based on the data received, the perception and understanding module 236 and the behaviors and planning module 238 determine whether or not to deploy the hail protection system 400. For example, the perception and understanding module 236 may receive data from the temperature sensor 218, cameras 214, an ambient weather sensor, and other sources, for example third party weather data or other vehicles in the fleet, indicating that hail is sensed in the ambient area near the hail protection system or may indicate that hail is likely to occur. Then based on this information the behaviors and planning module 238 may determine whether to deploy the hail protection system 400.

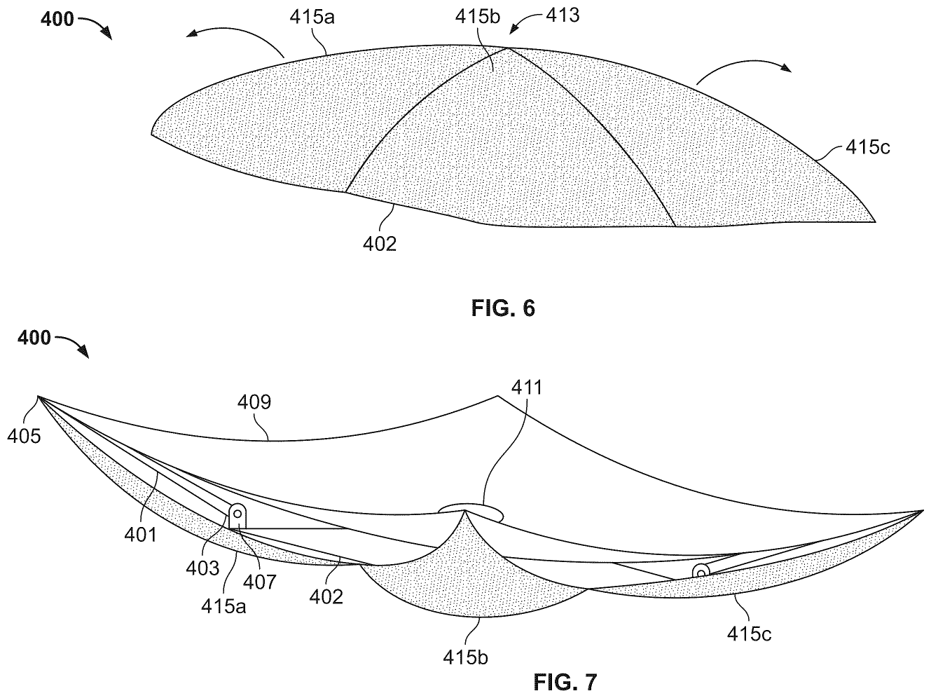

Referring now to FIGS. 6 and 7, illustrate a hail protection system 400 with a cover 413 according to another embodiment of the present disclosure. In some embodiments, the hail protection system 400 may include a cover 413 positioned over the base structure 402 and retracted arms 401 and collapsed sheet 409. The cover 413 may be made from plastic, metal, fiberglass, or another rigid or semi-rigid material. The cover 413 is movable between a retracted position and a deployed position along with the arms 401 and the sheet 409. In some embodiments, the cover 413, while in the retracted position, has an aerodynamic shape. In some embodiments, for example when the hail protection system 400 is mounted on a vehicle 100, the cover 413 may conform with contours and the shape of the vehicle 100 and produce the aerodynamic configuration.

In some embodiments, the cover 413 is made of a plurality of cover sections 415a-c. In some embodiments, each of the cover sections 415a-c is associated with and coupled to a corresponding arm 401. The cover sections 415a-c may be tied, welded, screwed or secured to the respective arm 401 at or near the second end 405 and the first end 403 or the hinge 407. In some embodiments, the cover section 415a-c is integrated with the respective arm 401 forming a unitary arm and cover section piece. Since the cover sections 415a-c are connected to a respective arm 401, each of the cover sections 415a-c moves with the respective arm 401 as the arm 401 moves between the retracted position and the deployed position. When the arms are moved to the retracted positions, the cover panels move into contact with the edges of adjacent cover sections to form the closed cover 413 of FIG. 6. In some embodiments, the cover sections 415 are attached to the base structure 402, for example via the hinge 407, and are not attached to the arm 401. In such embodiments, the cover sections 415 may be movable between the retracted position and the deployed position independently from the arm 401, for example by a separate motor or other means for rotating the cover sections 415 between retracted and deployed positions.

In some embodiments, the cover 413 may be augmented or replaced by a retractable cover, for example a convertible top type cover, or another type of cover, which is able to enclose the arms 401 and the sheet 409.

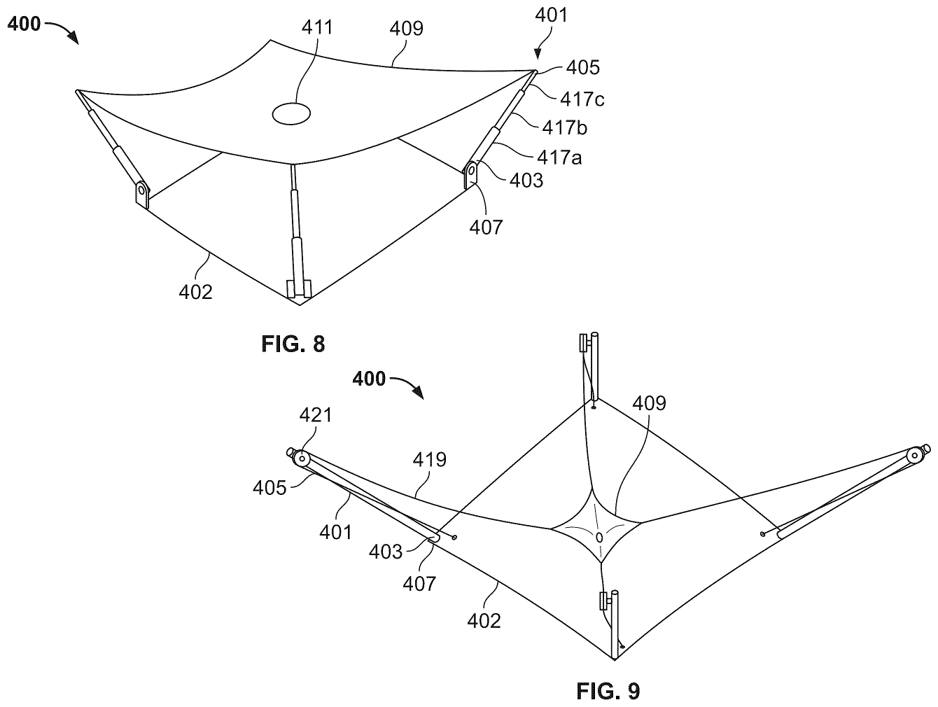

Referring now to FIG. 8, shown is a hail protection system 400 with arms 401 having a telescoping configuration according to some embodiments of the present disclosure. In some embodiments, the arms 401 may be telescoping arms comprising a number of stages 417 which are movable between a collapsed position and an extended position. The stages 417 distal to the base structure 402 are nested inside adjacent stages 417 proximal to the base structure 402 in the collapsed position. The arm 401 may be made of as many or as few stages 417 as necessary to achieve the desired arm length necessary to suitably extend sheet 409 to cover base 402 and/or sensors 202. As shown in FIG. 8, the arm 401 includes three stages 417a, 417b and 417c. When retracted, telescoping stage 417c nests within telescoping stage 417b and telescoping stage 417b nests within telescoping stage 417a.

In some embodiments, the plurality of stages 417 may be connected to the base structure 402 by the hinge 407 such that the arm 401 is moved between the retracted position and the deployed position while the stages 417 are telescopically collapsed. Once the arm 401 is in the deployed position, the stages 417 may be moved into the extend position by a motor or other means for extending and collapsing the telescoping arm. A signal is provided to the motors or other suitable device producing the desired arm movement. In some embodiments, the arms 401 in the telescoping configuration may be controlled by the autonomous vehicle 100 or the autonomy computing system 200 in the same or a similar manner as discussed herein. In this way, since the arm 401 is shorter when the stages 417 are collapsed, tension on the second end 405 of the arm 401 may be reduced when moving the arm 401 from the retracted position to the deployed position. In some embodiments, the arm 401 and the plurality of stages 417 may be housed inside of the base structure 402 and extend out of the base structure 402 directly into the deployed position without the need for the hinge 407.

Referring now to FIG. 9, shown is a partially deployed hail protection system 400 according to alternate embodiments of the present disclosure. In some embodiments, a cable 419 may be attached to the sheet 409. The cable 419 may be secured to an edge or corner of the sheet 409. A pulley 421 is attached to the arm 401 at or near the second arm end 405. A cable 419 is attached to the sheet 409, passed over the pulley and extended along the length of the arm until it is connected to the base 402.

In some embodiments, the cable 419 may have a variable length and be connected to a winch in or on the base structure 402. The winch may wind up the cable 419 pulling on the sheet 409. In this way, the winch, cable 419, and pulley 421 may operate in a similar manner to a sail on a boat, pulling the sheet 409 into the extended orientation. The sheet 409 may be stored in a cavity in the base structure 402, and be pulled by the cable 419 and winch into the extended orientation. In some embodiments, a corresponding cable and winch may be in the cavity in the base structure 402 for pulling the sheet 409 into the collapsed orientation. In some embodiments, the arms 401 are maintained in the deployed position and the winch, cable 419, and pulley 421 operate to move the sheet 409 between the collapsed orientation and the extended orientation.

In some embodiments, the cable 419 may have a fixed length and be affixed to the base structure 402. As the arms 401 are moved from the retracted position to the deployed position, the sheet 409 is also pulled into the extended orientation since the cable 419, being a fixed length, is sized and dimension such that the edge of the sheet 409, which the cable 419 is attached to, is positioned near the second end 405 when the arm 401 is in the deployed position, i.e., the length of cable 419 is slightly greater than the length of the arm 401 and the circumference of the pulley 421.

Referring now to FIG. 10, shown is a cross section view of a hail protection system 400 according to some embodiments of the present disclosure. The arms 401 may be positioned at an angle θ with respect to the horizontal of the base structure 402 when the arms 401 are in the deployed position. The angle θ may affect the area covered by the hail protection system 400. Whereby when 0 approaches 0 degrees, the arms 401 and the sheet 409 of the hail protection system 400 extend substantially parallel to or coplanar with, the base structure 402 and thereby covering a relatively larger area than when 0 is not approaching or equal to zero degrees. Alternatively, as 0 increases in magnitude, the hail protection system 400 covers a relatively smaller area beneath the system sheet 409. The angle θ of the arms 401 also has an impact on the distance H between the lowest portion of the sheet 409 and the base structure 402. As shown in FIG. 10, the distance H is measured from the portion of the sheet 409 where the orifice 411 is located to the base 402.

In some embodiments, based on the elasticity of the sheet 409, the distance H from the sheet 409 to the base structure 402 may be adjusted as desired by adjusting the angle θ of the arms 401. Adjusting the value H will ensure that the sheet and system are able to effectively absorb the kinetic energy of the hail and minimize damage to the base structure. For example, if the value of H is too small, the kinetic energy of the hailstones may not be fully absorbed or deflected resulting in damage to the underlying base structure 402.

In some embodiments, a flexible tube 423 may be attached to the orifice 411. The flexible tube 423 may be made of the same or a different material as the sheet 409. The flexible tube 423 may catch hailstones 1001 which fall directly into the orifice 411, thereby preventing the hailstones 1001 from making impact with the base structure 402 and providing a path for the hailstones to be displaced from the base or vehicle 100. Hailstones 1001 that land on the sheet 409 will roll into the orifice 411 and be directed off the base structure 402 by the flexible tube 423. In some embodiments, hailstones 1001 may impact the sheet 409 with such force that a puncture 425 is created in the sheet. In such instances, most of the kinetic energy of the hailstones 1001 may be dissipated by the sheet 409 resulting in no or minimal damage to the base structure 402. Furthermore, in such instances, it is unlikely that another hailstone 1001 will fall in the same place as the puncture 425 and any hailstones 1001 which fall near the puncture will be at least partially deflected by the material surrounding the puncture in the sheet 409.

In some embodiments, wind and hailstones 1001 contacting the sheet 409 will cause the sheet to displace or vibrate along with the flexible tube 423. This movement may prevent hailstones from collecting in, and clogging the flexible tube 423 and as a result, promote movement of the hailstones 1001 through the tube and away from the base 402.

Referring now to FIGS. 11-13, shown are exemplary embodiments of a hail protection system 400 mounted on an autonomous vehicle 100 and a trailer according to some embodiments of the present disclosure. As illustrated in FIG. 11, in some embodiments, the hail protection system 400 may be mounted on the roof of an autonomous vehicle 100.

As illustrated in FIG. 12, in some embodiments, one or more hail protection systems 400 may be mounted on individual sensors 202 on an autonomous vehicle 100. Multiple systems 400 are shown mounted on the trailer of FIG. 12. Each of the hail protections systems 400 may be operated in unison or independently. In some embodiments, certain sensors 202 may be more prone to damage and a particular hail protection system 400 may operate under different parameters based on the sensitivity of a particular sensor 202. For example, the behaviors and planning module 238 may have a different set of rules for each hail protection system 400 depending on the sensor 202 or other structure being protected and the severity of the hail storm. Also, for particular sensors, the protection system may be deployed if a storm is likely to occur, to protect the system integrity and operability.

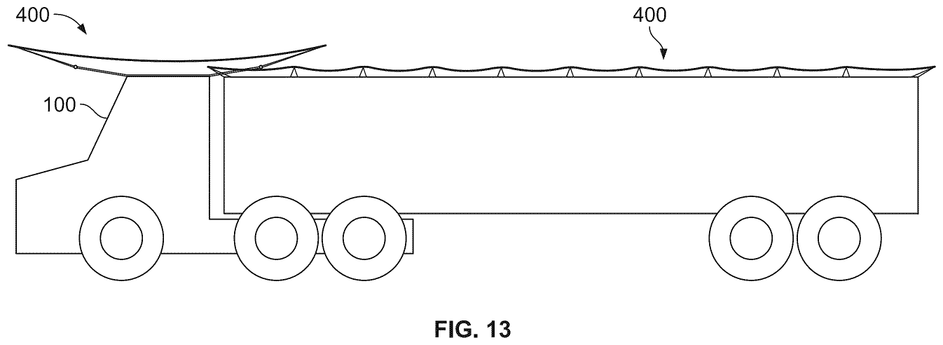

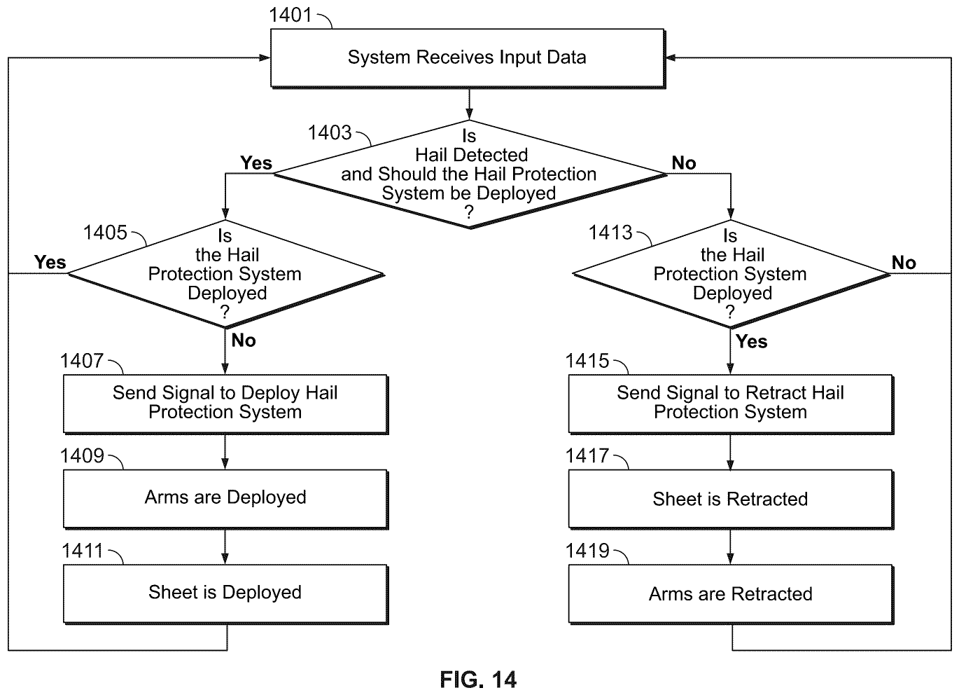

As Illustrated in FIG. 13, the hail protection system 400 may be deployed on an autonomous vehicle 100 and a trailer attached thereto. As discussed herein, each of the hail protections systems 400 may be operated in unison or independently. In some embodiments, the trailer may be more durable and a particular hail protection system 400 may operate under different parameters based on the structure being protected. In some embodiments, it may be desirable to only deploy the hail protection system 400 over the autonomous vehicle 100, since depending on the severity of the hail storm, the trailer may not be at risk of being damaged.

Referring now to FIG. 14, shown is a flow chart comprising a method of use of the hail protection system 400 according to some embodiments of the present disclosure. At 1401 the system, for example the autonomy computing system 200, receives input data. The input data may be data from sensors, for example the temperature sensor 218, cameras 216, or a weather sensor, or from a third parties, for example national weather services. In some embodiments, 1401 acts as a default state of the system whereby input data is received and the system determines what, if any action to take. In some embodiments, the system receives input data continuously, at set intervals, in response to a data request, or a data push, although not limited thereto.

At 1403 the system determines, based at least in part on the input data, whether hail is detected and if the hail protection system 400 should be deployed. In some embodiments, the system may determine a confidence interval that hail is currently falling proximate the vehicle based on the input data. For example, this may be determined using the perception and understanding module 236 of the autonomy computing system 200. This confidence interval may be compared against a threshold value to determine the system's required course of action. For example this analysis may be completed using the behaviors and planning module 238 of the autonomy computing system 200. When determining the confidence interval, the system may receive visual, audio, and temperature data which indicates it is not currently hailing, but receives data from the national weather service that it is either hailing or imminently will hail. Based on this information, the perception and understanding module 236 of the autonomy computing system 200 will determine a confidence interval that it is hailing. The confidence interval is then compared to a threshold value of whether to deploy the hail protection system 400. For example, the system may determine that there is a low likelihood it is currently hailing but out of an abundance of caution due to the sensitivity of the sensor or other structure being protected, determine that the hail protection system 400 should be deployed.

In the case where the system determines that the hail protection system 400 should be deployed, the system proceeds to 1405. At 1405, the system checks if the hail protection system 400 is already deployed. If the hail protection system 400 is already deployed, no action is necessary and the system proceeds back to 1401. If the hail protection system 400 is not deployed the system may proceed to 1407. In 1407, now that the system has determined that the hail protection system 400 should be deployed and is not deployed, a signal is sent to the hail protection system 400 to deploy the hail protection system 400. At 1409, the arms 401 of the hail protection system 400 are deployed and at 1411 the sheet 409 is deployed and suspended between the deployed arms 401. In some embodiments, 1409 and 1411 occur simultaneously. Once the hail protection system 400 is deployed, the system proceeds back to 1401, receiving input data and waiting for a new action to be prompted.

In the case where the system determines that the hail protection system 400 should not be deployed, the system proceeds to 1413. At 1413, the system checks if the hail protection system 400 is already deployed. If the hail protection system 400 is not already deployed, no action is necessary and the system may proceed back to 1401. If the hail protection system 400 is deployed the system proceeds to 1415. In 1405, when the system has determined that the hail protection system 400 should not be deployed and is presently deployed, a signal is sent to the hail protection system 400 to retract the hail protection system 400. At 1417, the sheet 409 of the hail protection system 400 is retracted and at 1419 the arms 401 are retracted. In some embodiments, 1417 and 1419 occur simultaneously. Once the hail protection system 400 is retracted, the system proceeds back to 1401, receiving input data and waiting for a new action to be prompted.

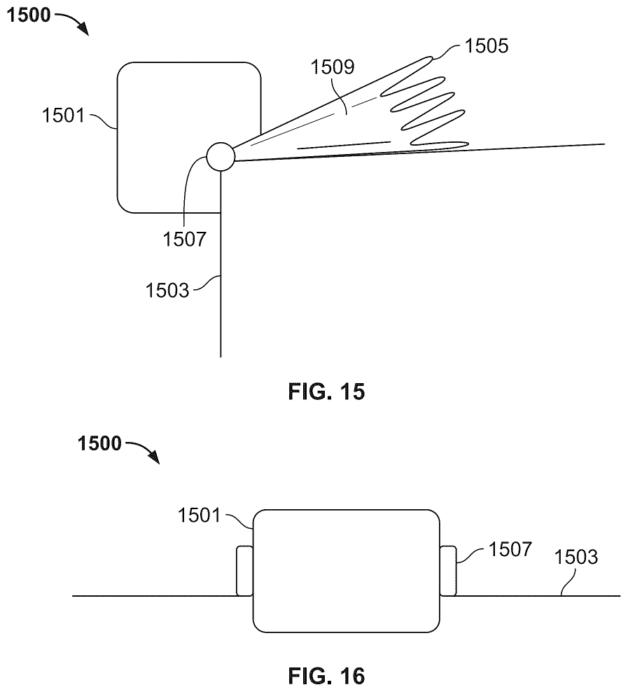

Referring now to FIGS. 15 and 16, shown is a weather protection system 1500 in a retracted position according to some embodiments of the present disclosure. The weather protection system 1500 includes a feature 1501, which the system is designed to protect, a base 1503, and a protection structure 1505 deployable around the feature 1501. The feature 1501 may be a sensor 202, headlights, a traffic camera, the hail protection system 400, or another feature which is prone to damage in adverse weather conditions. The base 1503 may be an autonomous vehicle 100, a street light, the base structure 402, or another structure which the feature 1501 is mounted on. The protection structure 1505 may be a ribbed frame, much like a convertible top, which is deployable over the feature 1501.

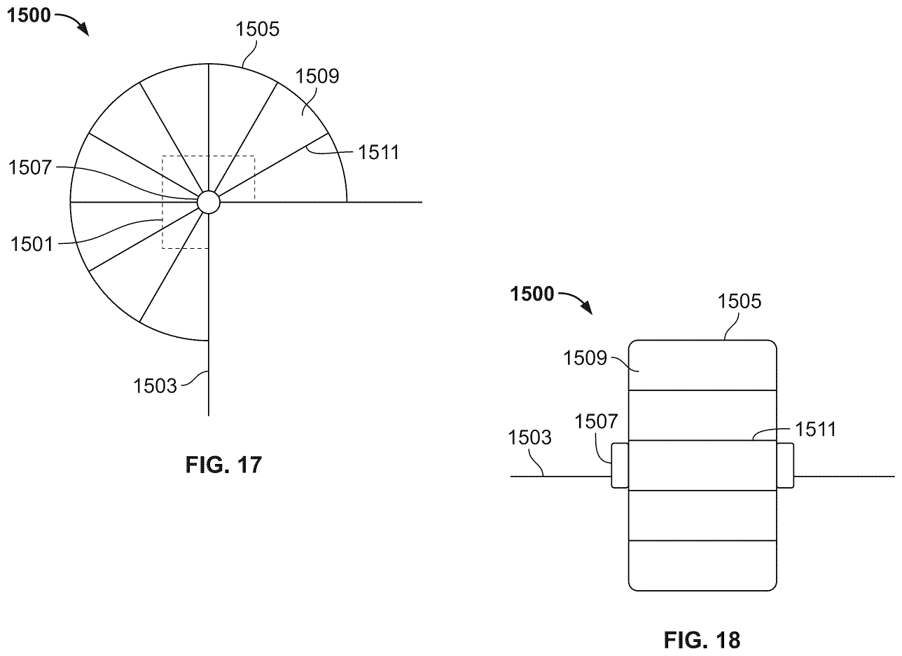

The protection structure 1505 may be attached to either feature 1501 or the base 1503 via a pivot point 1507. The protection structure 1505 may rotate about the pivot point 1507 when moving between a retracted position and deployed position. The protection structure 1505 may include a cover 1509 which connects individual ribs (shown in FIGS. 17 and 18) of the protection structure 1505. In some embodiments, the cover 1509 may be similar to the sheet 409. In some embodiments, the cover 1509 may be nested sheets of metal. In some embodiments, a leading edge of the protection structure 1505 may be molded to mate with a surface of the base 1503 when in the deployed position.

Referring now to FIGS. 17 and 18, shown is a weather protection system 1500 in a deployed position according to some embodiments of the present disclosure. As shown, when the protection structure 1505 is in the deployed position, the plurality of ribs 1511 are position about the pivot point 1507 around the feature 1501, with the cover 1509 bridging the gaps between each of the plurality of ribs 1511.

In some embodiments, the weather protection system 1500 is in data communication with the autonomous vehicle 100 or the autotomy computing system 200, such that the autonomous vehicle 100 or the autotomy computing system 200 can actuate the protection structure between the retracted position and the deployed position. Motors or other means for rotating the protection structure between the retracted and deployed positions are connected to protection structure at or near the pivot point. A signal is provided to the motors or other suitable device producing the desired arm movement. Sensors 202, for example the temperature sensor 218 or cameras 214, may provide data to the autonomy computing system 200 to detect current weather conditions such as hail, snow, sand storms, etc., whereby the perception and understanding module 236 and the behaviors and planning module 238 may determine whether or not to deploy the weather protection system 1500. For example, the perception and understanding module 236 may receive data from the temperature sensor 218, cameras 214, an ambient weather sensor, and other sources, for example third party weather data or other vehicles in the fleet, to determine if inclement weather is likely to occur. Then based on this information the behaviors and planning module 238 may determine whether to deploy the weather protection system 1500.

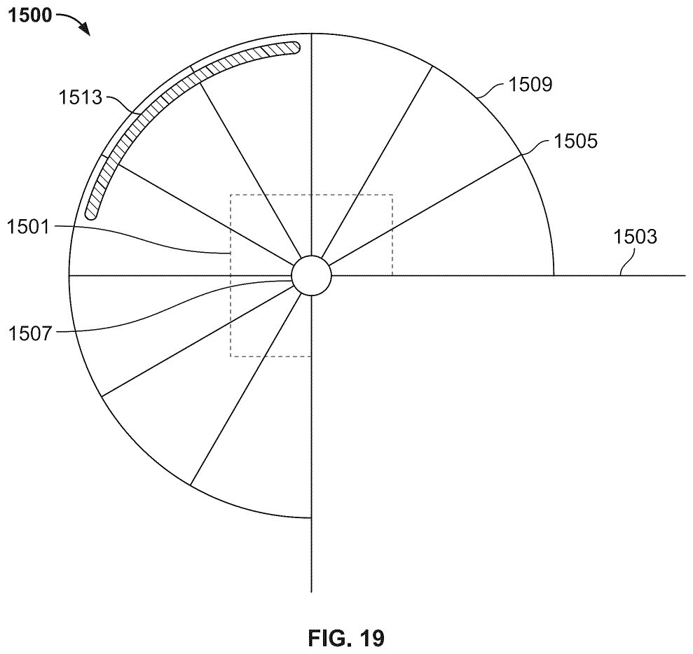

Referring now to FIG. 19, shown in a weather protection system 1500 with a reinforcing plate 1513 according to some embodiments of the present disclosure. In some embodiments, a plate 1513 may be mounted on the interior or exterior of the protection structure 1505 providing additional protection on targeted areas of the protection structure 1505. For example, areas on the protection structure 1505 which face the sky are more likely to be impacted by falling hailstones as opposed to the underside of the protection structure 1505. Accordingly, such areas are more likely to receive a direct impact from, for example, a hailstone and at a higher risk to be punctured. The plate 1513 may be position is these areas to provide an additional layer of protection which may increase the useable lifespan of the weather protection system 1500.

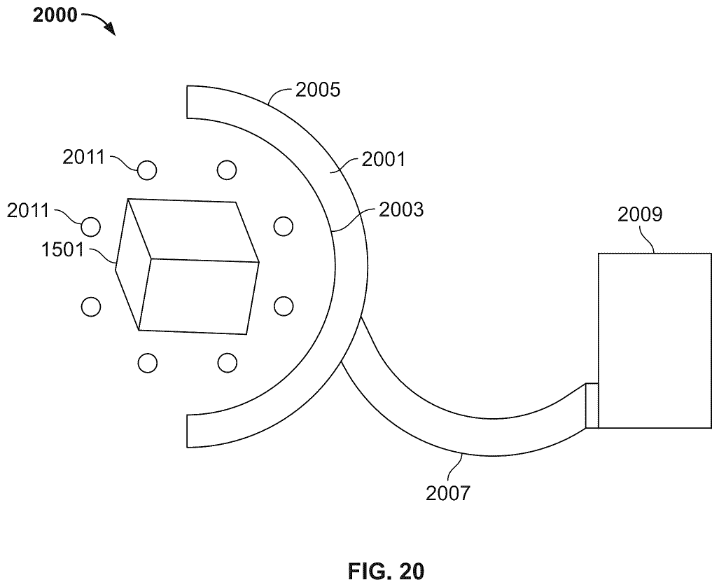

Referring now to FIG. 20, shown is an inflatable weather protection system 2000 according to some embodiments of the present disclosure. An inflatable structure 2001 may be positioned around a feature 1501 much like the protection structure 1505. The inflatable structure 2001 having an inner layer 2003 and an outer layer 2005. The inflatable structure 2001 is connected to an air valve tube 2007 and a pump 2009. In some embodiments, the inner later 2003 and the outer layer 2005 may be sized and dimensioned such that when the inflatable structure 2001 is inflated, the inflatable structure 2001 moves into a deployed position surrounding the feature 1501. For example, the inner layer 2003 and the outer layer 2005 may be pre-shaped concentric domes made of a semi-rigid material, such that the inflatable structure 2001 forms a dome over the feature 1501 when inflated. In some embodiments, the inflatable weather protection system 2000 may include tracks around the feature 1501 which guide the inflatable structure 2001 around the feature 1501 as the inflatable structure 2001 is inflated.

The inflatable weather protection system 2000 may also include a plurality of vents 2011 positioned around the feature 1501 and within the area of the inflatable structure 2001 in the deployed position. The plurality of vents 2011 may be connected to the air tube 2007 and the pump 2009, being selectively operated by a series of valves or may be connected to a separate air tube and pump. In some embodiments, when the inflatable structure 2001 is in the deployed position around the feature 1501, the inflatable structure 2001 may form an air tight or semi air tight seal around the feature 1501. The vents 2011, being in the air tight or semi air tight volume created by the inflatable structure 2001 around the feature 1501 may inflate the volume creating a positive back pressure relative to the environment. In this way, any break of the seal is met with positive back pressure which may blow away unwanted debris. For example, during sandstorms, a gust of wind may partially dislodge the inflatable structure 2001, attempting to blow sand into the interior volume; however, in such instances the positive back pressure created by the vents 2011 may counter act the gust of wind. Alternatively, in some embodiments, the vents 2011 may act as a vacuum, suctioning the inner layer 2003, or a film thereon, against the feature 1501, creating a tight protective seal.

In some embodiments, the inflatable weather protection system 2000 is in data communication with the autonomous vehicle 100 or the autotomy computing system 200, such that the autonomous vehicle 100 or the autotomy computing system 200 can control inflation and deflation of the inflatable structure 2001. A signal is provided to the pump 2009 or other suitable device producing the desired inflation or deflation. Sensors 202, for example the temperature sensor 218 or cameras 214, may provide data to the autonomy computing system 200 to detect current weather conditions such as hail, snow, sand storms, etc., whereby the perception and understanding module 236 and the behaviors and planning module 238 may determine whether or not to deploy the inflatable weather protection system 2000. For example, the perception and understanding module 236 may receive data from the temperature sensor 218, cameras 214, an ambient weather sensor, and other sources, for example third party weather data or other vehicles in the fleet, to determine if inclement weather is likely to occur. Then based on this information the behaviors and planning module 238 may determine whether to deploy the inflatable weather protection system 2000.

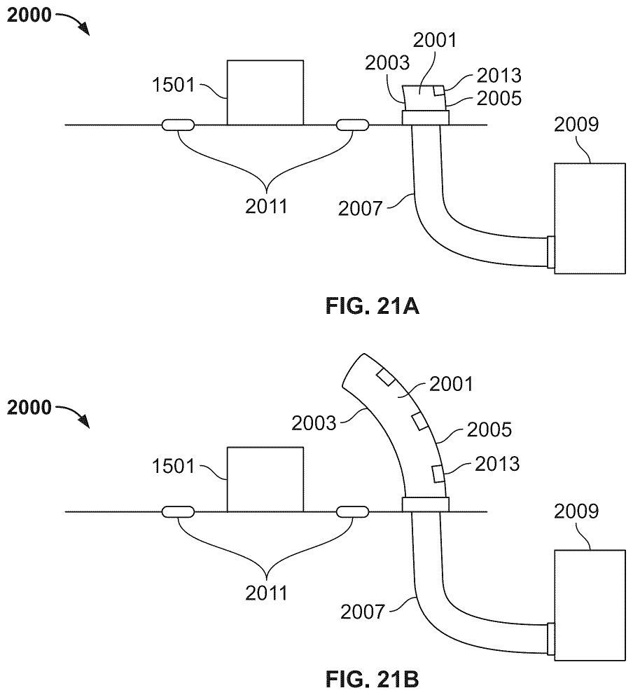

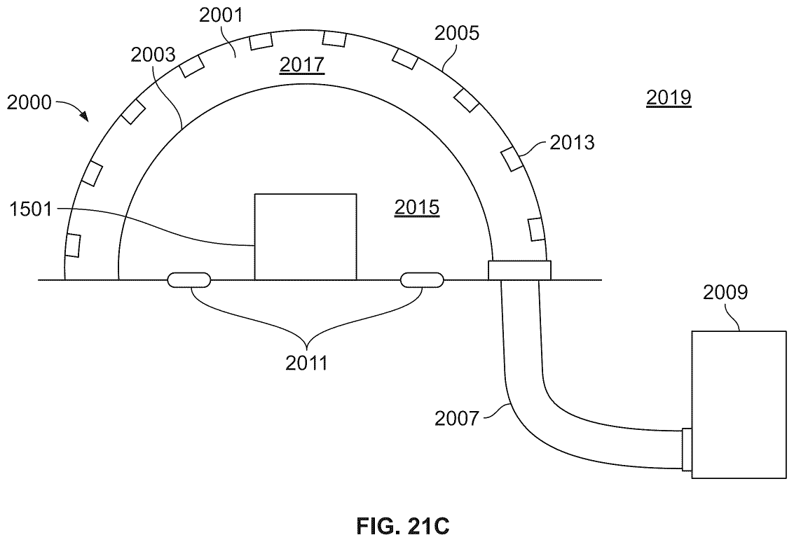

Referring now to FIGS. 21A-C, shown is an inflation and deployment sequence of the inflatable weather protection system 2000 according to some embodiments of the present disclosure. FIGS. 21A-C show a cross section of the inflatable weather protection system 2000, whereby FIG. 21A shows the inflatable structure 2001 in a retracted and deflated position. As the pump 2009 begin inflating the inflatable structure 2001, the size and dimensions of the inner layer 2003 and the outer layer 2005 may cause the inflatable structure 2001 to begin surrounding the feature 1501, illustrated in FIG. 21B. The inflatable structure 2001 may include ribs 2013 which provide additional structural support to the inflatable structure 2001 and may also direct the inflatable structure 2001 to surround the feature 1501 while being inflated.

As shown in FIG. 21C, once the inflatable structure 2001 is fully inflated and deployed around the feature 1501, the inflatable structure defines three volumes, an interior volume 2015 between the feature 1501 and the inner layer 2003, an inflation volume 2017 being the volume of the inflatable structure 2001, and the ambient environment 2019. In some embodiments, the interior volume 2015 may be an air tight or semi-air tight volume and the vents 2011 may inflate the interior volume 2015, creating a positive back pressure relative to the environment 2019, or may vacuum the inner layer 2003, or a film thereon, for example a rubber film, against the feature 1501.

In some embodiments, the ribs 2013 may provide additional protection on targeted areas of the inflatable structure 2001. The ribs 2013 may provide a similar role to the plate 1513, providing an additional layer of protection at higher risk areas of the inflatable structure 2001. In some embodiments, a plate is mounded on one or more of the ribs 2013 providing a larger area of protection.

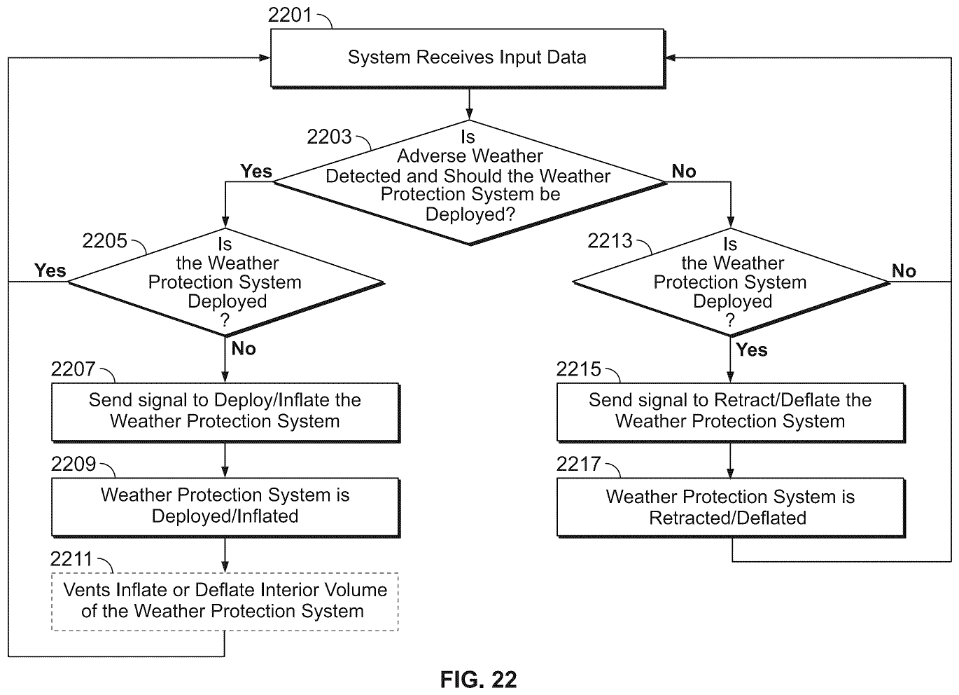

Referring now to FIG. 22, shown is a flow chart depicting a method of use of a weather protection system 1500, 2000 according to some embodiments of the present disclosure. At 2201 the system, for example the autonomy computing system 200, receives input data. The input data may be data from sensors, for example the temperature sensor 218, cameras 216, wind speed sensor, a humidity sensor, or a weather sensor, or from a third parties, for example national weather services. In some embodiments, 2201 acts as a default state of the system whereby input data is received and the system determines what action to take if any. In some embodiments, the system receives input data continuously, at set interval, in response to a data request, or a data push, although not limited thereto.

At 2203 the system determines, based at least in part on the input data, whether adverse weather is detected and if the weather protection system 1500, 2000 should be deployed. In some embodiments, the system may determine a confidence interval that a particular weather condition is currently occurring or likely to occur based on the input data, for example using the perception and understanding module 236 of the autonomy computing system 200. This confidence interval may be compared against a threshold value to determine the system course of action, for example using the behaviors and planning module 238 of the autonomy computing system 200. For example, when determining the confidence interval, the system may receive visual, audio, and temperature data which indicates calm weather, but receives data from the national weather service that adverse weather, for example a sandstorm, in imminent. Based on this information, the perception and understanding module 236 of the autonomy computing system 200 will determine a confidence interval that there is a sandstorm. The confidence interval is then compared to a threshold value of whether to deploy the weather protection system 1500, 2000 for a particular weather condition. For example, the system may determine that it there is heavy rain and the weather protection system 1500, 2000 does not need to be deployed; however, if conditions worsen and then system determines there is a typhoon, for example, the system may then deploy the weather protection system 1500, 2000.

In the case where the system determines that the weather protection system 1500, 2000 should be deployed, the system proceeds to 2205. At 2205, the system checks if the weather protection system 1500, 2000 is already deployed. If the weather protection system 1500, 2000 is already deployed, no action is necessary and the system proceeds back to 2201 to continue monitoring the environment receiving input data. If the weather protection system 1500, 2000 is not deployed the system proceeds to 2207, whereby a signal is sent to the weather protection system 1500, 2000 to be deployed. At 2209, the protection structure 1505 or the inflatable structure 2001 are deployed.

In some embodiments, where the weather protection system 2000 includes an air tight or semi air tight interior volume 2015, the system is equipped with vents 2011 and at 2211 the vents 2011 are used to either inflate, creating positive back pressure relative to the environment in the interior volume 2015 between the inner layer 2003 and the feature 1501, or deflates the interior volume 2015, vacuuming the inner layer 2003, or a film thereof, against the feature 1501. In some embodiments, 2209 and 2211 occur simultaneously, i.e., the vents 2011 begin inflation or defeating the interior volume 2015. Once the weather protection system 1500, 2000 is deployed, the system proceeds back to 2201, receiving input data and waiting for a new action to be prompted.

In the case where the system determines that the weather protection system 1500, 2000 should not be deployed, the system proceeds to 2213. At 1413, the system checks if the weather protection system 1500, 2000 is already deployed. If the weather protection system 1500, 2000 is not deployed, no action is necessary and the system proceeds back to 2201. If the weather protection system 1500, 2000 is deployed the system proceeds to 2215. In 2205, now that the system has determined that the weather protection system 1500, 2000 should not be deployed and is deployed, a signal is sent to the weather protection system 1500, 2000 to retract the weather protection system 1500, 2000. At 2217, the protection structure 1505 or the inflatable structure 2001 are deployed. Once the weather protection system 1500, 2000 is retracted, the system proceeds back to 2201, receiving input data and waiting for a new action to be prompted.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A system for adverse weather protection comprising:
a feature; and
a structure adjacent to the feature, the structure having a first layer and a second layer;
wherein the structure is inflatable around the feature defining a first volume between the feature and the first layer, a second volume between the first layer and the second layer and a third volume external to second layer;
wherein, the first layer and the second layer are sized and dimensioned such that when the second volume is inflated the structure expands around the feature.

2. The system of claim 1, wherein the structure includes a plurality of ribs between the first layer and the second layer.

3. The system of claim 1, further comprising one or more vents in the first volume.

4. The system of claim 3, wherein the one or more vents deflate the first volume vacuuming the first layer against the feature.

5. The system of claim 3, wherein the one or more vents inflate the first volume to have positive pressure relative to the third volume.

6. The system of claim 1, further comprising at least one processor configured to receive signals and to execute instructions stored in at least one memory to perform the operations comprising:
controlling a pump operatively connected to the first volume and the second volume;
selectively inflating and deflating the first volume and the second volume.

7. The system of claim 1, wherein the feature and the structure are mounted on an autonomous vehicle.

8. The system of claim 1, further comprising one or more plates mounted on the second layer.

9. A system for adverse weather protection comprising:
a feature;
a structure adjacent to the feature, the structure having a plurality of ribs and a cover attached to the plurality of ribs, the structure being movable between a retracted position and a deployed position;
wherein when the structure is in the deployed position, the plurality of ribs are arranged around the feature and the cover surrounds the feature.

10. The system of claim 9, wherein each of the plurality of spokes share a pivot point and rotate about the pivot point around the feature when moving between the retracted position and the deployed position.

11. The system of claim 9, further comprising one or more vents surrounded by the cover when the structure is in the deployed position, the one or more vents being operatively connected to a pump.

12. The system of claim 11, wherein the pump is activated to supply air under the cover via the one or more vents to create a positive pressure under the cover relative to an exterior of the cover.

13. The system of claim 12, further comprising at least one processor configured to receive signals and to execute instructions stored in at least one memory to perform the operations comprising:
moving the structure between the retracted position and the deployed position;
activating the pump.

14. A method for automatic protection against adverse weather comprising:
detecting an adverse weather condition;
transmitting a first signal indicative of the adverse weather condition to an adverse weather protection system, the adverse weather protection system comprising:
a feature;
an structure adjacent to the feature, the structure having a first layer and a second layer, the structure is expandable around the feature defining a first volume between the feature and the first layer, a second volume between the first layer and the second layer and a third volume external to the second layer, and the first layer and the second layer are sized and dimensioned such that when the second volume is inflated the structure expands around the feature; and
at least one processor configured to receive signals and to execute instructions stored in at least one memory to control a pump operatively connected to the first volume and the second volume;
inflating the second volume to expand the structure around the feature in response to the first signal;
detecting if the extreme weather condition has stopped;
transmitting a second signal indicative that the extreme weather condition has stopped to the extreme weather protection system; and
deflating the second volume in response to the second signal.

15. The method of claim 14, further comprising deflating the first volume, vacuuming the first layer against the feature after inflating the second volume.

16. The method of claim 14, further comprising inflating the first volume to have positive pressure relative to the third volume after inflating the second volume.

17. The method of claim 14, further comprising determining whether to inflate the second volume based at least in part on the adverse weather condition detected.

18. The method of claim 14, wherein detecting an adverse weather condition detecting if the extreme weather condition has stopped comprises evaluating input data from at least one of a sensor or a third party.

19. The method of claim 18, wherein the sensor is part of an autonomous vehicle.
